(19) United States
(12) Patent Application Publication
(10) Pub. No.: US 2010/0233545 A1
(43) Pub. Date: Sep. 16, 2010

(54) ACTIVE MATERIAL, METHOD OF MANUFACTURING ACTIVE MATERIAL, ELECTRODE, AND LITHIUM-ION SECONDARY BATTERY

(75) Inventors: Atsushi SANO, Tokyo (JP); Keitaro OTSUKI, Tokyo (JP); Yousuke MIYAKI, Tokyo (JP); Takeshi TAKAHASHI, Tokyo (JP); Akiji HIGUCHI, Kyoto-shi (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/723,101

(22) Filed: Mar. 12, 2010

(30) Foreign Application Priority Data
Mar. 16, 2009 (JP) P2009-062981
Mar. 16, 2009 (JP) P2009-063118

(51) Int. Cl. H01M 4/48; H01M 4/88; H01M 4/485

(52) U.S. Cl. 429/231.5; 252/182.1; 428/402; 428/403

(57) ABSTRACT

The first aspect of the invention provides a method of manufacturing an active material capable of selectively synthesizing β-LiVOPO₄. The method of manufacturing an active material in accordance with the first aspect comprises a hydrothermal synthesis step of heating a mixture containing a lithium source, a phosphate source, a vanadium source, and water and having a pH of 7 or less; and a firing step of firing the mixture after being heated under pressure in the hydrothermal synthesis step. The second aspect of the invention provides an active material capable of attaining a sufficient discharge capacity at a high discharge current density, an electrode containing the same, and a lithium-ion secondary battery containing the electrode. The active material in accordance with the second aspect contains an active material particle mainly composed of LiVOPO₄ having a β-type crystal structure and a plurality of hemispherical carbon particles, supported on a surface of the active material particle, having a height of 5 to 20 nm, and has an average primary particle size of 50 to 1000 nm.

### BACKGROUND OF THE INVENTION

1. Field of the Invention

The present invention relates to an active material, a method of manufacturing an active material, an electrode containing the active material, and a lithium-ion secondary battery equipped with the electrode.

2. Related Background Art

LiVOPO₄, which is a positive electrode active material capable of reversibly inserting and desorbing lithium ions, is used for active material layers in lithium-ion secondary batteries. LiVOPO₄ has been known to exhibit a plurality of crystal structures such as those of triclinic (α-type) and orthorhombic (β-type) crystals and have different electrochemical characteristics depending on their crystal structures (see Japanese Patent Application Laid-Open Nos. 2004-303527 and 2003-68304, Solid State Ionics, 140, pp. 209-221 (2001), J. Power Sources, 97-98, pp. 532-534 (2001), and J. Baker et al., J. Electrochem. Soc., 151, A796 (2004)).

Japanese Patent Application Laid-Open No. 2004-303527 discloses making LiVOPO₄ having the β-type (orthorhombic) crystal structure and LiVOPO₄ having the α-type triclinic structure by a solid-phase method and using them as electrode active materials for nonaqueous electrolytic secondary batteries. It is stated that the discharge capacity of the nonaqueous electrolytic secondary batteries becomes higher when using LiVOPO₄ having the β-type crystal structure than when using LiVOPO₄ having the α-type (triclinic) structure.

J. Baker et al., J. Electrochem. Soc., 151, A796 (2004) discloses a method (carbothermal reduction method (CFR method)) heating VOPO₄ and Li₂CO₃ in the presence of carbon and reducing Li₂CO₃ with carbon, thereby making LiVOPO₄ having the β-type crystal structure.

### SUMMARY OF THE INVENTION

### First Aspect of Invention

The β-type crystal of LiVOPO₄ (which will hereinafter be referred to as “β-LiVOPO₄” when appropriate) is superior to the α-type crystal of LiVOPO₄ (which will hereinafter be referred to as “α-LiVOPO₄” when appropriate) in terms of the characteristic of reversibly inserting and desorbing lithium ions (which will hereinafter be referred to as “reversibility” when appropriate). Therefore, batteries using β-LiVOPO₄ as their active material have a higher charge/discharge capacity and better rate and cycle characteristics as compared with those using α-LiVOPO₄. For such a reason, β-LiVOPO₄ is preferred over α-LiVOPO₄ as an active material. Therefore, a method for selectively synthesizing β-LiVOPO₄ is desired.

However, β-LiVOPO₄ is thermally less stable than α-LiVOPO₄. That is, β-LiVOPO₄ is a metastable phase, whereas α-LiVOPO₄ is a stable phase. As can be inferred from this fact, even when trying to synthesize β-LiVOPO₄ selectively, α-LiVOPO₄ tends to mingle into the resulting product. For example, conventional methods such as those mixing, pulverizing, and firing solids to become materials for LiVOPO₄ and those dissolving materials for LiVOPO₄ into water and then drying them by evaporation are hard to synthesize β-LiVOPO₄ selectively. On the other hand, the ionic and electronic conductivities of β-LiVOPO₄ obtained by the conventional manufacturing methods have not always been high, so that the discharge capacity of batteries using conventional β-LiVOPO₄ has not sufficiently been higher than their theoretical capacity. Therefore, β-LiVOPO₄ suitable for an electrode material has not been attained yet.

In view of the problems of the prior art mentioned above, it is an object of the first aspect of the present invention to provide a method of manufacturing an active material which can selectively synthesize β-LiVOPO₄, an active material obtained by the method of manufacturing an active material and capable of improving the discharge capacity of a lithium-ion secondary battery, an electrode using the active material, and a lithium-ion secondary battery using the electrode.

For achieving the above-mentioned object, the method of manufacturing an active material in accordance with the first aspect of the present invention comprises a hydrothermal synthesis step of heating a mixture containing a lithium source, a phosphate source, a vanadium source, and water and having a pH of 7 or less; and a firing step of firing the mixture after being heated under pressure in the hydrothermal synthesis step.

When the mixture as a starting material for the hydrothermal synthesis has a pH of 7 or less, β-LiVOPO₄ can be synthesized selectively. Since β-LiVOPO₄ is synthesized by the hydrothermal synthesis, the volume-average primary particle size of β-LiVOPO₄ can be reduced, while the particle size distribution can be made sharper.

Preferably, in the method of manufacturing an active material in accordance with the first aspect of the present invention, at least one of nitric acid, hydrochloric acid, and sulfuric acid is added to the mixture in the hydrothermal synthesis step before heating.

This makes it easier to adjust the pH of the unheated mixture to a desirable value of 7 or less.

Preferably, in the method of manufacturing an active material in accordance with the first aspect of the present invention, the lithium source is at least one species selected from the group consisting of LiNO₃, Li₂CO₃, LiOH, LiCl, Li₂SO₄, and CH₃COOLi; the phosphate source is at least one species selected from the group consisting of H₃PO₄, NH₄H₂PO₄, (NH₄)₂HPO₄, and Li₃PO₄; and the vanadium source is at least one species selected from the group consisting of V₂O₅ and NH₄VO₃.

Using these lithium, phosphate, and vanadium sources in an appropriate combination makes it easier to adjust the pH of the unheated mixture to a desirable value of 7 or less.

Preferably, in the method of manufacturing an active material in accordance with the first aspect of the present invention, the lithium source is Li₂CO₃, the phosphate source is H₃PO₄, and the vanadium source is V₂O₅.

This makes it easier to synthesize β-LiVOPO₄ selectively.

The active material in accordance with the first aspect of the present invention comprises a particle group having a β-type crystal structure of LiVOPO₄ and a volume-average primary particle size of 50 to 1000 nm.

The electrode in accordance with the first aspect of the present invention comprises a current collector and an active material layer, disposed on the current collector, containing the active material in accordance with the first aspect of the present invention.

The lithium-ion secondary battery in accordance with the first aspect of the present invention comprises the electrode in accordance with the first aspect of the present invention.

The particle group having the β-type crystal structure of LiVOPO₄ (which will hereinafter be referred to as “β-LiVOPO₄ particle group” when appropriate) is superior to particle groups having the α-type crystal structure of LiVOPO₄ in terms of reversibility (Li ion release and uptake efficiencies).

In the first aspect of the present invention, the β-LiVOPO₄ particle group has a volume-average primary particle size of 50 to 1000 nm, which is smaller than that of the conventional α- or β-LiVOPO₄ particle groups. Therefore, as compared with the conventional active materials, the first aspect of the present invention increases the density of ion conduction paths and shortens the Li ion diffusion length within particles, thereby enhancing the diffusing capacity of Li ions. Also, in the first aspect of the present invention, the β-LiVOPO₄ particle group attains a specific surface area greater than that conventionally available, so as to improve the reversibility and increase the contact area between the current collector and particle group and the contact area between a conductive agent typically contained in the active material and the particles, thereby raising the density of electron conduction paths.

Because of the foregoing reasons, the active material in accordance with the first aspect of the present invention improves the ionic and electronic conductivities and capacity density over the conventional active materials. Therefore, the lithium-ion secondary battery using the active material in accordance with the first aspect of the present invention improves the discharge capacity over those using the conventional LiVOPO₄ particle groups.

Preferably, as counted from the smaller primary particle side in a volume-based particle size distribution of the particle group determined by a laser scattering method in the active material in accordance with the first aspect of the present invention, a primary particle size d10 at a cumulative volume ratio of 10% is 0.2 to 1.5 nm, a primary particle size d50 at a cumulative volume ratio of 50% is 2 to 10 nm, and a primary particle size d90 at a cumulative volume ratio of 90% is 15 to 50 nm.

This can homogenize ionic and electronic conductivities in the electrode comprising the active material layer containing the active material in accordance with the first aspect of the present invention.

Preferably, in the active material in accordance with the first aspect of the present invention, the particle group has a specific surface area of 1 to 10 m²/g.

This further improves the reversibility of the β-LiVOPO₄ particle group,

Preferably, in the electrode in accordance with the first aspect of the present invention, the active material layer contains 80 to 97 mass % of the particle group.

This makes it easier to improve the discharge capacity of the lithium-ion secondary battery.

The first aspect of the present invention can provide a method of manufacturing an active material which can selectively synthesize β-LiVOPO₄, an active material obtained by the method of manufacturing an active material and capable of improving the charge capacity of a lithium-ion secondary battery, an electrode using the active material, and a lithium-ion secondary battery using the electrode.

### Second Aspect of Invention

The active materials containing LiVOPO₄ having a β-type crystal structure obtained by the methods described in Japanese Patent Application Laid-Open No. 2004-303527 and J. Baker et al., J. Electrochem. Soc., 151, A796 (2004) failed to attain a sufficient discharge capacity at a high discharge current density.

It is therefore an object of the second aspect of the present invention to provide an active material capable of attaining a sufficient discharge capacity at a high discharge current density, an electrode containing the same, a lithium-ion secondary battery containing the electrode, and a method of manufacturing the active material.

For achieving the above-mentioned object, the active material in accordance with the second aspect of the present invention contains an active material particle mainly composed of LiVOPO₄ having a β-type crystal structure and a plurality of hemispherical carbon particles, supported on a surface of the active material particle, having a height of 5 to 20 nm, and has an average primary particle size of 50 to 1000 nm.

In the second aspect of the present invention, the active material can attain a sufficient discharge capacity at a high discharge current density by having the structure and particle size mentioned above. The reason therefor is not clear but inferred as follows. Firstly, by having the structure and particle size mentioned above, the active material in accordance with the second aspect of the present invention attains a particle size equivalent to or less than 50 to 1000 nm, thus yielding a greater specific surface area, thereby increasing the contact area with an electrolytic solution. This seems to make it easier to diffuse lithium ions into crystal lattices of LiVOPO₄, thereby facilitating the insertion and desorption of lithium ions.

Secondly, since the carbon particles in the active material have a height of 5 to 20 nm and a hemispherical form, the contact area between the active material particle and the electrolytic solution becomes greater than that in the case where a film is formed by a carbon material, for example, whereby the ionic conductivity secured; while the contact area between the active material particle and the carbon particles becomes greater than that in the case where spherical carbon particles are supported, for example, whereby the electronic conductivity is secured. This seems to make it possible to satisfy the ionic and electronic conductivities at the same time.

The electrode in accordance with the second aspect of the present invention comprises a current collector and an active material layer, disposed on the current collector, containing the above-mentioned active material. This can yield an electrode having a high discharge capacity.

The lithium ion secondary battery in accordance with the second aspect of the present invention comprises the above-mentioned electrode. This can yield a lithium-ion secondary battery having a high discharge capacity.

The method of manufacturing an active material in accordance with the second aspect of the present invention comprises a hydrothermal synthesis step of heating a mixture containing a lithium source, a vanadium source, a phosphate source, carbon black, and water and having a pH of 7 or less; so as to yield a precursor of LiVOPO₄ having a β-type crystal structure; and a firing step of heating the precursor of LiVOPO₄ having the β-type crystal structure at 530 to 670° C., so as to yield LiVOPO₄ having the n-type crystal structure.

The method of manufacturing an active material in accordance with the second aspect of the present invention can yield the active material in accordance with second aspect of the present invention having the structure mentioned above. This makes it possible to obtain an active material capable of attaining a sufficient discharge capacity at a high discharge density, an electrode containing the same, and a lithium-ion secondary battery containing the electrode.

The second aspect of the present invention can provide an active material which can attain a sufficient discharge capacity at a high discharge density, an electrode containing the same, a lithium-ion secondary battery containing the electrode, and a method of manufacturing the active material.

### BRIEF DESCRIPTION OF THE DRAWINGS

FIG. 1A is a graph illustrating a light-intensity-based particle size distribution A of an unheated precursor of Example 1, a light-intensity-based particle size distribution B of a powder obtained by heating the precursor of Example 1 at 450° C., and a light-intensity-based particle size distribution C of the active material of Example 1. FIG. 1B is a graph illustrating a volume-based particle size distribution A of the unheated precursor of Example 1, a volume-based particle size distribution B of the powder obtained by heating the precursor of Example 1 at 450° C., and a volume-based particle size distribution C of the active material of Example 1. FIG. 1C is a graph illustrating a particle-number-based particle size distribution A of the unheated precursor of Example 1, a particle-number-based particle size distribution B of a powder obtained by heating the precursor of Example 1 at 450° C., and a particle-number-based particle size distribution C of the active material of Example 1.

FIG. 2 is a schematic sectional view of the active material in accordance with a second embodiment.

FIG. 3 is a schematic sectional view of a lithium-ion secondary battery comprising an active material layer containing the active material in accordance with a first or second embodiment.

FIG. 4 is a TEM image of the active material in Example 13.

### DESCRIPTION OF THE PREFERRED EMBODIMENTS

### Preferred Embodiment of First Aspect of Invention

A preferred embodiment of the first aspect of the present invention will be referred to as “first embodiment” in this specification. In the following, a method of manufacturing an active material in accordance with the first embodiment will be explained. The first embodiment explains a case where the active material is constituted by a particle group of β-LiVOPO₄ alone. That is, the active material and the β-LiVOPO₄ particle group are synonymous with each other in the first embodiment. The active material may contain conductive agents and the like in addition to the particle group in other embodiments of the first aspect of the present invention.

Method of Manufacturing an Active Material

The method of manufacturing an active material in accordance with the first embodiment comprises a hydrothermal synthesis step of heating a mixture containing a lithium source, a phosphate source, a vanadium source, and water and having a pH of 7 or less; and a firing step of firing the mixture after being heated under pressure in the hydrothermal synthesis step.

Hydrothermal Synthesis Step

First, in the hydrothermal synthesis step, the above-mentioned lithium source, phosphate source, vanadium source, and water are put into a reaction vessel having, a function of heating and pressurizing the inside thereof (e.g., autoclave), so as to prepare a mixture (aqueous solution) having them dispersed therein. For preparing the mixture, a mixture of the phosphate source, vanadium source, and water may be refluxed at first before adding the lithium source thereto, for example. The reflux can form a complex of the phosphate and vanadium sources.

The pH of the mixture is adjusted to 7 or less. This makes it possible to synthesize β-LiVOPO₄ selectively. The pH of the mixture is preferably 1.0 or greater, more preferably 1.8 to 6.7. Impurities are easier to mingle into β-LiVOPO₄ when the pH of the mixture is too low, whereas α-LiVOPO₄ tends to occur when the pH of the mixture is too high.

While various methods can be employed as a method for adjusting the pH of the mixture to 7 or less, adding at least one of nitric acid, hydrochloric acid, and sulfuric acid to the mixture is preferred. Their amounts of addition may be adjusted as appropriate depending on the amount of the mixture and the species and compounding ratios of the lithium, phosphate, and vanadium sources.

Another preferred method for adjusting the pH of the mixture to 7 or less is combining specific lithium, phosphate, and vanadium sources. That is, containing a combination of specific lithium, phosphate, and vanadium sources as materials for β-LiVOPO₄ in the mixture makes it easier to adjust the pH of the mixture to a desirable value of 7 or less.

Specifically, it is preferable to use at least one species selected from the group consisting of LiNO₃, Li₂CO₃, LiCl, Li₂SO₄, and CH₃COOLi as the lithium source; at least one species selected from the group consisting of H₃PO₄, NH₄H₂PO₄, (NH₄)₂HPO₄, and Li₃PO₄ as the phosphate source; and at least one species selected from the group consisting of V₂O₅ and NH₄VO₃ as the vanadium source. Table 1 lists combinations of lithium, phosphate, and vanadium sources and pH values of mixtures attained thereby. For adjusting the pH to 7 or less by the lithium, phosphate, and vanadium sources alone, it will be sufficient if a combination yielding a pH of 7 or less among the combinations listed in Table 1 is employed.

TABLE 1

| Combination | 1 | 2 | 3 | 4 | 5 | 6 | 7 | 8 | 9 |
|---|---|---|---|---|---|---|---|---|---|
| Vanadium source | V₂O₅ | V₂O₅ | V₂O₅ | V₂O₅ | V₂O₅ | V₂O₅ | V₂O₅ | V₂O₅ | V₂O₅ |
| Phosphate source | H₃PO₄ | H₃PO₄ | (NH₄)H₂PO₄ | H₃PO₄ | (NH₄)H₂PO₄ | (NH₄)₂HPO₄ | H₃PO₄ | (NH₄)H₂PO₄ | (NH₄)₂HPO₄ |
| Lithium source | LiNO₃ | LiNO₃ | LiNO₃ | Li₂CO₃ | Li₂CO₃ | Li₂CO₃ | LiOH | LiOH | LiOH |
| | or LiCl | or LiCl | or LiCl | | | | | | |
| | or Li₂SO₄ | or Li₂SO₄ | or Li₂SO₄ | | | | | | |
| Other | — | NH₃ | — | — | — | — | — | — | — |
| pH | 1.78 | 9.24 | 8.07 | 3.55 | 8.7 | 9.1 | 2.69 | 10.5 | 11.2 |

Among the compounds mentioned above, it is preferable to use Li₂CO₃ as the lithium source, H₃PO₄ as the phosphate source, and V₂O₅ as the vanadium source. This makes it easier to synthesize β-LiVOPO₄ selectively.

It will be sufficient if the compounding ratios of the lithium, phosphate, and vanadium sources in the mixture are adjusted such as to yield a composition expressed by LiVOPO₄. For example, Li₂CO₃, V₂O₅, and H₃PO₄ may be compounded at a ratio of 1:1:2.

The pH adjusting method based on the addition of nitric acid, hydrochloric acid, or sulfuric acid and that based on the combination of the lithium, phosphate, and vanadium sources may be used together. This can finely adjust the pH. Two or more species of lithium sources, two or more species of phosphate sources, and two or more species of vanadium sources may be used together. This can finely adjust the pH. Two or more combinations among the combinations 1 to 9 listed in Table 1 may be used together.

Next, the reaction vessel is closed, and the mixture is heated under pressure, so that a hydrothermal reaction of the mixture proceeds. This hydrothermally synthesizes a precursor of a β-LiVOPO₄ particle group.

Preferably, the pressure applied to the mixture in the hydrothermal synthesis step is 0.2 to 1 MPa. When the pressure applied to the mixture is too low, the finally obtained β-LiVOPO₄ particle group tends to lower its crystallinity, thereby decreasing the capacity density of the active material. When the pressure applied to the mixture is too high, the reaction vessel tends to require a high pressure resistance, thereby increasing the cost for manufacturing the active material. These tendencies can be suppressed when the pressure applied to the mixture falls within the range mentioned above.

Preferably, the temperature of the mixture in the hydrothermal synthesis step is 150 to 200° C. When the temperature of the mixture is too low, the finally obtained β-LiVOPO₄ particle group tends to lower its crystallinity, thereby decreasing the capacity density of the active material. When the temperature of the mixture is too high, the reaction vessel tends to require a high heat resistance, thereby increasing the cost for manufacturing the active material. These tendencies can be suppressed when the temperature of the mixture falls within the range mentioned above.

Firing Step

In the firing step, the mixture (precursor of the β-LiVOPO₄ particle group) after being heated under pressure in the hydrothermal synthesis step is fired. This yields the β-LiVOPO₄ particle group.

Preferably, the firing temperature of the mixture in the firing step is 600 to 700° C. When the firing temperature is too low, the crystal growth of β-LiVOPO₄ tends to become insufficient, thereby lowering the capacity density of the active material. When the firing temperature is too high, β-LiVOPO₄ tends to grow its particles, so as to increase their sizes, thereby retarding the diffusion of lithium in the active material and lowering the capacity density of the active material. These tendencies can be suppressed when the firing temperature falls within the range mentioned above.

Preferably, the firing time for the mixture is 3 to 20 hr. Preferably, the firing atmosphere for the mixture is a nitrogen, argon, or air atmosphere.

The mixture obtained in the hydrothermal synthesis step may be heat-treated for 1 to 30 hr at a temperature of about 60 to 150° C. before firing in the firing step. The heat treatment turns the mixture into a powder. Thus obtained powdery mixture may be fired. This can remove surplus moisture and organic solvent from the mixture, prevent crystals of β-LiVOPO₄ type particles from taking up impurities, and homogenize particle forms.

The above-mentioned method of manufacturing an active material in accordance with the first embodiment can selectively obtain the β-LiVOPO₄ particle group. That is, the first embodiment can prevent α-LiVOPO₄ from occurring and improve the yield and purity of the β-LiVOPO₄ particle group. The method of manufacturing an active material in accordance with the first embodiment can also make the β-LiVOPO₄ particle group have a volume-average primary particle size of 50 to 1000 nm and sharpen the particle size distribution.

Examples of conventionally known methods of manufacturing an active material include one mixing, pulverizing, and firing solids to become materials for LiVOPO₄, so as to form particles of LiVOPO₄, and then mixing them with carbon; and one dissolving materials for LiVOPO₄ into water and drying them by evaporation, so as to form particles of LiVOPO₄, and then mixing them with carbon. These methods, however, are hard to synthesize the β-LiVOPO₄ particle group, not to mention to reduce the volume-average primary particle size of the β-LiVOPO₄ particle group such that it fails within the range of 50 to 1000 nm.

Active Material

The active material in accordance with the first embodiment will now be explained. The active material in accordance with the first embodiment can be manufactured by the above-mentioned method of manufacturing an active material.

The active material in accordance with the first embodiment comprises a particle group having the β-type crystal structure of LiVOPO₄. The volume-average primary particle size of the particle group is 50 to 1000 nm. Preferably, the volume-average particle size of the particle group is 100 to 500 nm. The volume-average primary particle size of the particle group may be measured by a laser scattering method.

Since the β-type crystal structure of LiVOPO₄ has a more linear and shorter ion conduction path than that of the α-type crystal structure, the particle group having the β-type crystal structure is superior to that having the α-type crystal structure in terms of reversibility.

When the volume-average primary particle size of the particle group is too small, the discharge capacity tends to decrease. When the volume-average primary particle size of the particle group is too large, the reversibility, diffusing capacity of Li ions, and densities of ion and electron conduction paths tend to decrease. These tendencies can be suppressed by the first embodiment when the volume-average primary particle size of the particle group falls within the range mentioned above.

Preferably, as counted from the smaller primary particle side in a volume-based particle size distribution of the particle group determined by a laser scattering method, a primary particle size d10 at a cumulative volume ratio of 10% is 0.2 to 1.5 nm, a primary particle size d50 at a cumulative volume ratio of 50% is 2 to 10 nm, and a primary particle size d90 at a cumulative volume ratio of 90% is 15 to 50 nm.

This can homogenize the ionic and electronic conductivities in a positive electrode comprising an active material layer containing the β-LiVOPO₄ particle group.

Preferably, the specific surface area of the β-LiVOPO₄ particle group is 1 to 10 m²/g. When the specific surface area is too small, the reversibility, diffusing capacity of Li ions, and densities of ion and electron conduction paths tend to decrease. When the specific surface area is too large, the active material and battery tend to lower their heat resistance. These tendencies can be suppressed in the first embodiment when the specific surface area of the β-LiVOPO₄ particle group falls within the range mentioned above. The specific surface area may be measured by a BET method.

Lithium-Ion Secondary Battery

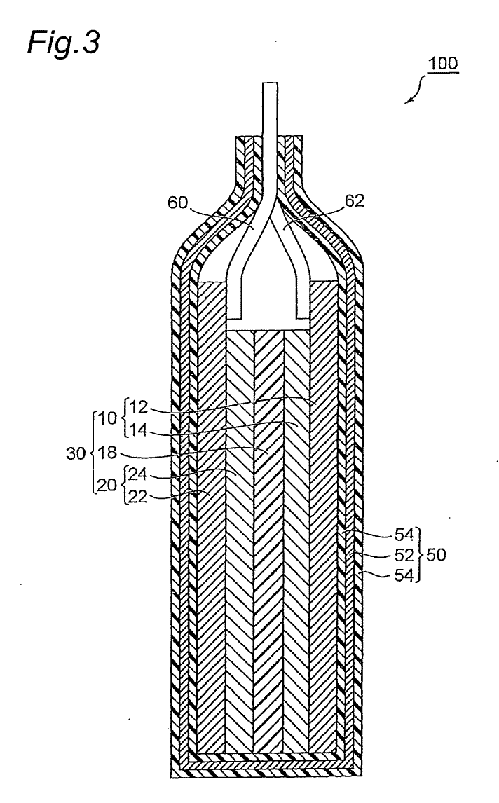

A lithium-ion secondary battery 100 in accordance with the first embodiment illustrated in FIG. 3 is equipped with a power generating element 30 comprising planar positive and negative electrodes 10, 20 opposing each other and a planar separator 18 disposed between and adjacent to the positive and negative electrodes 10, 20; an electrolytic solution containing lithium ions; a case 50 accommodating them in a closed state; a negative electrode lead 60 having one end part electrically connected to the negative electrode and the other end part projecting out of the case; and a positive electrode lead 62 having one end part electrically connected to the positive electrode and the other end part projecting out of the case.

The negative electrode 20 has a negative electrode current collector 22 and a negative electrode active material layer 24 formed on the negative electrode current collector 22. The positive electrode 10 has a positive electrode current collector 12 and a positive electrode active material layer 14 formed on the positive electrode current collector 12. The separator 18 is placed between the negative electrode active material layer 24 and positive electrode active material layer 14.

The positive electrode active material layer 14 contains a β-LiVOPO₄ particle group having a volume-average primary particle size of 50 to 1000 nm. The positive electrode active material layer 14 may further contain a conductive agent such as activated carbon, carbon black (graphite), soft carbon, or hard carbon.

Since the positive electrode active material layer 14 in the first embodiment contains the β-LiVOPO₄ particle group that is superior to conventional active materials in terms of the ionic and electronic conductivities and the capacity density, the discharge capacity, rate characteristic, and cycle characteristic of the lithium-ion secondary battery 100 are improved over those conventionally available.

Preferably, the active material layer 14 contains the β-LiVOPO₄ particle group by 80 to 97 mass %. When the β-LiVOPO₄ particle group content is too small, the ionic and electronic conductivities and capacity density tend to decrease, thereby lowering the discharge capacity of the battery. When the β-LiVOPO₄ particle group content is too large, the conductive agent tends to occupy a greater portion of the positive electrode active material layer 14, thereby lowering the electronic conductivity of the positive electrode active material layer 14. These tendencies can be suppressed by the first embodiment when the β-LiVOPO₄ particle group content falls within the range mentioned above.

Though the active material, method of manufacturing an active material, electrode, and lithium-ion secondary battery of the first embodiment are explained in detail in the foregoing, the first aspect of the present invention is not limited to the first embodiment.

For example, the active material of the first aspect of the present invention can also be used as an electrode material for electrochemical devices other than the lithium-ion secondary battery. Examples of such electrochemical devices include secondary batteries other than the lithium-ion secondary battery, e.g., metallic lithium secondary batteries (using an electrode containing the active material of the first aspect of the present invention as a cathode and metallic lithium as an anode), and electrochemical capacitors such as lithium capacitors. These electrochemical devices can be used for power supplies for self-propelled micromachines, IC cards, and the like and decentralized power supplies placed on or within printed boards.

### EXAMPLES OF FIRST ASPECT OF INVENTION

The first aspect of the present invention will now be explained more specifically with reference to examples and comparative examples, but will not be limited to the following Examples 1 to 6.

### Example 1

### Hydrothermal Synthesis Step

Into a 1.5-L autoclave vessel, 23.3 g (0.2 mol) of an aqueous H₃PO₄ solution (special grade having a molecular weight of 98.00 and a purity of 85 wt % manufactured by Nacalai Tesque, Inc.), 503 g of H₂O (for HPLC (high-performance liquid chromatography), manufactured by Nacalai Tesque, 18.37 g (0.1 mol) of V₂O₅ (special grade having a molecular weight of 181.88 and a purity of 99 wt % manufactured by Nacalai Tesque, Inc.), and 7.40 g (0.1 mol) of Li₂CO₃ (special grade having a molecular weight of 73.89 and a purity of 99 wt % manufactured by Nacalai Tesque, Inc.) were introduced in this order, so as to prepare a mixture having a pH of 3.5. These amounts of materials correspond to amounts for stoichiometrically generating about 30 g (0.2 mol) of LiVOPO₄ (having a molecular weight of 168.85).

With the vessel closed, the mixture was stirred for about 30 min at room temperature, and then was refluxed at 160° C./200 rpm for 16 hr under a pressure of 0.5 MPa within the vessel, so that a hydrothermal synthesis reaction proceeded. After the hydrothermal synthesis reaction, the pH of the mixture was 2.3.

Water was added to the mixture after the hydrothermal synthesis reaction, and then the mixture was transferred onto a tray and dried for about 21 hr at 90° C. by evaporation. After being dried by evaporation, the mixture was pulverized, so as to yield a deep orange powder (precursor of an active material).

Firing Step

In an alumina crucible, 5.00 g of the precursor were fired for 4 hr at 600° C. and then rapidly cooled. The powder was fired in an air atmosphere. In the firing step, the firing temperature was raised from room temperature to 450° C. in 45 min. This firing step yielded 4.27 g of a somber green particle group (an active material of Example 1).

Measurement of the Crystal Structure

The result of Rietveld analysis based on powder X-ray diffraction (XRD) proved that the active material of Example 1 comprised a particle group of LiVOPO₄ and that the ratio α/β between the number of moles α of the α-type crystal phase of LiVOPO₄ (which will hereinafter be referred to as “α-phase” when appropriate) existing in the particle group and the number of moles β of the β-type crystal phase of LiVOPO₄ (which will hereinafter be referred to as “β-phase” when appropriate) existing in the particle group was 0.01.

Measurement of Particle Size Distributions

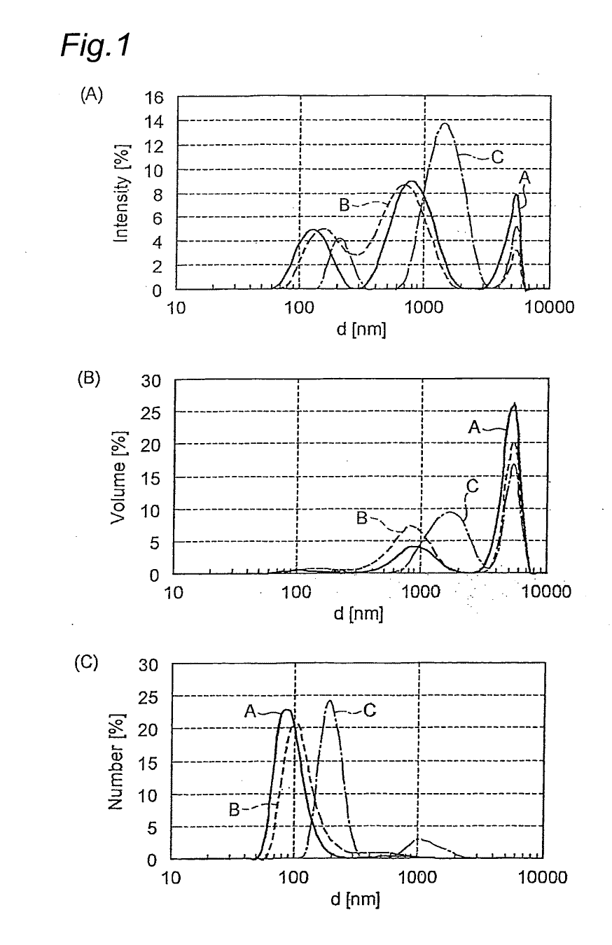

Particle size distributions of the active material of Example 1 were measured by a laser scattering method (dynamic light scattering method). For measuring the particle size distributions, an apparatus manufactured by Malvern Instruments Ltd was used. FIG. 1A illustrates a light-intensity-based particle size distribution C of the active material of Example 1. FIG. 1B illustrates a volume-based particle size distribution C of the active material of Example 1. FIG. 1C illustrates a particle-number-based particle size distribution C of the active material of Example 1.

FIG. 1A illustrates a light-intensity-based particle size distribution A of the unheated precursor of Example 1. FIG. 1B illustrates a volume-based particle size distribution A of the unheated precursor of Example 1. FIG. 1C illustrates a particle-number-based particle size distribution A of the unheated precursor of Example 1.

FIG. 1A illustrates a light-intensity-based particle size distribution B of the powder (hereinafter referred to as “powder B”) obtained by firing the precursor of Example 1 for 4 hr at 600° C. FIG. 1B illustrates a volume-based particle size distribution B of the powder B. FIG. 1C illustrates a particle-number-based particle size distribution B of the powder B.

The volume-average primary particle size of the active material of Example 1 calculated from the volume-based particle size distribution was 320 nm. The particle size distribution of the active material of Example 1 was such that, as counted from the smaller primary particle side, the primary particle size d10 at a cumulative volume ratio of 10% was 0.2 to 1.5 nm, the primary particle size d50 at a cumulative volume ratio of 50% was 2 to 10 nm, and the primary particle size d90 at a cumulative volume ratio of 90% was 15 to 50 nm.

Measurement of the Discharge Capacity

The active material of Example 1 and a mixture of polyvinylidene fluoride (PVDF) as a binder and acetylene black were dispersed into N-methyl-2-pyrrolidone (NMP) acting as a solvent, so as to prepare a slurry. The slurry was prepared such that the weight ratio among the active material, acetylene black, and PVDF became 84:8:8 therein. The slurry was applied onto an aluminum foil acting as a current collector, dried, and then extended under pressure, so as to yield an electrode (positive electrode) formed with an active material layer containing the active material of Example 1.

Thus obtained electrode and an Li foil acting as its opposite electrode were subsequently laminated with a separator made of a macroporous polyethylene film interposed therebetween, so as to yield a multilayer body (matrix). This multilayer body was put into an aluminum-laminated pack, a 1-M LiPF₆ solution was injected therein as an electrolytic solution, and then the pack was sealed in vacuum, so as to make an evaluation cell of Example 1.

Using the evaluation cell of Example 1, the discharge capacity (unit: mAh/g) at a discharge rate of 0.1 C (the current value by which constant-current discharging at 25° C. completed in 10 hr) was measured. Table 2 represents the measured results.

### Example 2

The active material and evaluation cell of Example 2 were obtained by the same method as that of Example 1 except that the mixture before the hydrothermal synthesis reaction contained 20.7 g of LiNO₃ instead of Li₂CO₃.

### Example 3

The active material and evaluation cell of Example 3 were obtained by the same method as that of Example 1 except that the mixture before the hydrothermal synthesis reaction contained 7.2 g of LiOH instead of Li₂CO₃.

### Example 4

In Example 4, the mixture before the hydrothermal synthesis reaction contained (NH₄)H₂PO₄ instead of H₃PO₄, and 20.7 g of LiNO₃ instead of Li₂CO₃. Also, hydrochloric acid was added to the mixture before the hydrothermal synthesis reaction, so as to adjust the pH of the mixture in Example 4. Except for the foregoing matters, the active material and evaluation cell of Example 4 were obtained by the same method as that of Example 1.

### Example 5

In Example 5, the mixture before the hydrothermal synthesis reaction contained (NH₄)H₂PO₄ instead of H₃PO₄, and 20.7 g of LiNO₃ instead of Li₂CO₃. Also, hydrochloric acid was added to the mixture before the hydrothermal synthesis reaction, so as to adjust the pH of the mixture in Example 5. Except for the foregoing matters, the active material and evaluation cell of Example 5 were obtained by the same method as that of Example 1.

### Example 6

In Example 6, the mixture before the hydrothermal synthesis reaction contained (NH₄)H₂PO₄ instead of H₃PO₄, and 20.7 g of LiNO₃ instead of Li₂CO₃. Also, hydrochloric acid was added to the mixture before the hydrothermal synthesis reaction, so as to adjust the pH of the mixture in Example 6. Except for the foregoing matters, the active material and evaluation cell of Example 6 were obtained by the same method as that of Example 1.

### Comparative Example 1

LiNO₃, V₂O₅, and H₃PO₄ were dissolved into water so as to attain a molar ratio of 2:1:2 and stirred at 80° C., thereby preparing an aqueous solution. The aqueous solution was dried by evaporation and then further dried for one night at 110° C. A solid obtained after the drying was pulverized and then heated for 14 hr in the air, so as to yield the active material of Comparative Example 1. The evaluation cell of Comparative Example 1 was obtained by the same method as that of Example 1 except that the active material of Comparative Example 1 was used.

### Comparative Example 2

The active material and evaluation cell of Comparative Example 2 were obtained by the same method as that of Example 1 except that the mixture before the hydrothermal synthesis reaction contained 20.7 g of LiNO₃ instead of Li₂CO₃ and further contained 49.0 g of aqueous ammonia having a concentration of 28 wt %.

### Comparative Example 3

The active material and evaluation cell of Comparative Example 3 were obtained by the same method as that of Example 1 except that the mixture before the hydrothermal synthesis reaction contained 20.7 g of LiNO₃ instead of Li₂CO₃, and 39.6 g of NH₄H₂(PO₄) instead of the aqueous H₃PO₄ solution.

### Comparative Example 4

A mixture having a pH of 0 was obtained as in Example 2 except that concentrated hydrochloric acid was added as a solvent to the mixture before the hydrothermal synthesis reaction. Using this mixture, the making of an active material was tried by the same method as that of Example 1. However, due to a large amount of impurities produced, the active material of Comparative Example 4 could not be made.

The pH of the mixture was determined by the same method as that of Example 1 before and after the hydrothermal synthesis reaction in each of Examples 2 to 6 and Comparative Examples 2 and 3. The crystal structure and volume-average primary particle size of the active material and the discharge capacity of the evaluation cell in each of Examples 2 to 6 and Comparative Examples 1 to 3 were determined by the same methods as those of Example 1. Table 2 lists the results. It was seen that each of the active materials of Examples 1 to 6 and Comparative Examples 1 to 3 was LiVOPO₄. In Table 2, the crystal structure of the active material is referred to as “α” when α/β is greater than 0.05. The crystal structure of the active material is referred to as “β” when α/β is smaller than 0.05 or only the β phase is detected without the α phase. The (α/β ratio smaller than 0.05 or having detected only the β phase without the α phase means that β-LiVOPO₄ was selectively synthesized.

TABLE 2

| | pH of mixture | | | | | Volume-average |
|---|---|---|---|---|---|---|
| | Before | After | Discharge | | | primary |
| | hydrothermal | hydrothermal | capacity | Crystal structure | | particle size |
| | synthesis | synthesis | (mAh/g) | α/β | | (nm) |
| Example 1 | 3.5 | 2.3 | 120 | 0.01 | β | 320 |
| Example 2 | 1.8 | 1.5 | 116 | α undetected | β | 58 |
| Example 3 | 2.5 | 2.1 | 130 | α undetected | β | 121 |
| Example 4 | 5.8 | 3 | 128 | 0.03 | β | 500 |
| Example 5 | 6.7 | 4 | 118 | 0.05 | β | 980 |
| Example 6 | 4.2 | 2.6 | 120 | 0.02 | β | 982 |
| Comparative | — | — | 77 | 0.09 | α | 850 |
| Example 1 | | | | | | |
| Comparative | 9.2 | 5.3 | 73 | 0.49 | α | 790 |
| Example 2 | | | | | | |
| Comparative | 8.1 | 4.6 | 82 | 0.12 | α | 680 |
| Example 3 | | | | | | |

As Table 2 represents, it was seen that each of the active materials of Examples 1 to 6 in which the pH of the mixture before the hydrothermal synthesis reaction was 7 or less exhibited the β-type crystal structure of LiVOPO₄, an α/β ratio smaller than 0.05, and a volume-average primary particle size of 50 to 1000 nm. By contrast, it was seen that each of the active materials of Comparative Examples 2 and 3 in which the pH of the mixture before the hydrothermal synthesis reaction was 7 or greater exhibited an α/β ratio of 0.12 or greater, thus having a greater amount of the α phase as compared with the examples.

The active material of Comparative Example 1 obtained without the hydrothermal synthesis reaction was seen to have both α- and β-type crystal structures. The Rietveld analysis of the active material of Comparative Example 1 proved that it contained about 8 mol % of α-LiVOPO₄.

As in the foregoing, Examples 1 to 6 were seen to be easier to synthesize β-LiVOPO₄ than Comparative Examples 1 to 3. It was also seen that the evaluation cells of Examples 1 to 6 yielded discharge capacities higher than those of Comparative Examples 1 to 3.

Reference Signs List of FIG. 1

d . . . particle size; A . . . particle size distribution of the precursor before heating in Example 1; B . . . particle size distribution of the powder obtained by heating the precursor of Example 1 at 450° C.; C . . . particle size distribution of the active material of Example 1

### Preferred Embodiment of Second Aspect of Invention

In this specification, a preferred embodiment of the second aspect of the present invention will be referred to as “second embodiment”. In the following, the preferred embodiment of the second aspect of the present invention will be explained with reference to the accompanying drawings. Ratios of dimensions in the drawings do not always match those in practice.

Active Material

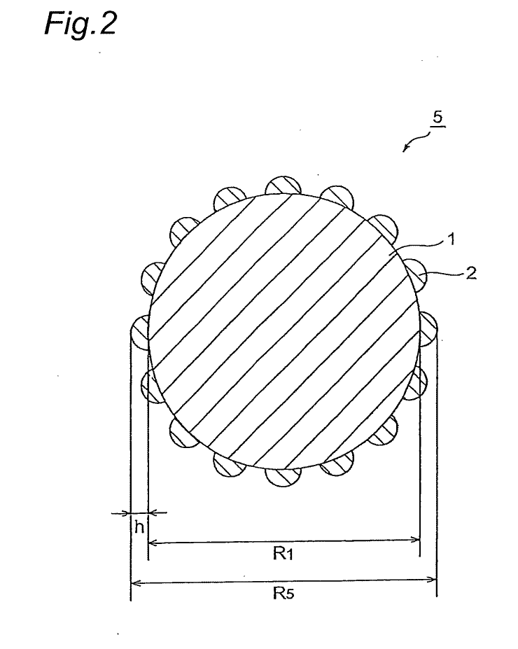

An active material in accordance with the second embodiment will be explained. FIG. 2 is a schematic sectional view of an active material 5 in accordance with the second embodiment. The active material 5 of the second embodiment contains an active material particle 1 and a plurality of hemispherical carbon particles 2. The active material 5 has an active material particle mainly composed of LiVOPO₄ having the β-type crystal structure as a support (core) and hemispherical carbon particles having a height of 5 to 20 nm on the surface of the support. The active material 5 has an average primary particle size R₅ of 50 to 1000 nm.

The “average primary particle size R₅ of the active material” defined in the second aspect of the present invention refers to the value of d50 at a cumulative ratio of 50% in a number-based particle size distribution measured for the active material 5. The number-based particle size distribution of the active material 5 can be calculated from the cumulative ratio of the projected area circle-equivalent diameter determined from a projected area of the active material 5 based on an image observed through a high-resolution scanning electron microscope, for example. The projected area circle-equivalent diameter represents the diameter (circle-equivalent diameter) of a sphere assumed to have the same projected area as that of a particle (active material 5) as the particle size (of the active material 5).

Preferably, in the number-based particle size distribution of the active material 5 calculated from the value of the projected area circle-equivalent diameter, the primary particle size d10 at a cumulative volume ratio of 10% is 10 to 50 nm, the primary particle size d50 at a cumulative volume ratio of 50% is 50 to 1000 nm, and the primary particle size d90 at a cumulative volume ratio of 90% is 1000 to 10000 nm.

When the average primary particle size R₅ (d50) exceeds 1000 nm, The discharge capacity tends to deteriorate. When the average primary particle size R₅ (d50) is less than 50 nm, on the other hand, the carbon particles are harder to support.

The term “mainly composed of LiVOPO₄ having the β-type crystal structure” Means that the amount of LiVOPO₄ having the β-type crystal structure in the active material particle 1 is at least 90%, preferably at least 95%, by mass. While a typical example of the components other than LiVOPO₄ having the β-type crystal structure is LiVOPO₄ having the α-type crystal structure, the particle may contain minute amounts of unreacted material components and the like in addition to LiVOPO₄. Here, the amounts of LiVOPO₄ having the β-type crystal structure, LiVOPO₄ having the α-type crystal structure, and the like in the particle can be determined by an X-ray diffraction method, for example. Typically, LiVOPO₄ having the β-type crystal structure exhibits a peak at 2θ=27.0 degrees, whereas LiVOPO₄ having the α-type crystal structure exhibits a peak at 2θ=27.2 degrees. Preferably, LiVOPO₄ having the α-type crystal structure is 10 mass % or less of LiVOPO₄ having then-type crystal structure.

The hemispherical carbon particles 2 have a height h of 5 to 20 nm and are supported on the surface of the active material particle 1 such that convexes are formed on the side opposite from the active material particle 1 as illustrated in FIG. 2. The “height of the hemispherical carbon particle 2” defined in the second aspect of the present invention refers to the height from the surface of the active material particle 1 to the vertex of the convex of the hemispherical carbon particle 2. When the height h exceeds 20 nm, the discharge capacity tends to decrease, which may be due to the fact that the ionic conductivity decreases as the height increases. When the height h is less than 5 nm, on the other hand, the discharge capacity tends to decrease, which may be due to the fact that the ionic conductivity decreases as the surface coverage increases. The carbon particles are not arranged so densely that a plurality of hemispherical carbon particles 2 form a film on the surface of the active material particle 1, for example, but exist like dots such as to be mostly separated from each other as illustrated in FIG. 2.

The height and state of existence of the hemispherical carbon particles 2 can be observed Through TEM or the like. The ratio by which the hemispherical carbon particles 2 cover the surface of the active material particle 1 (surface coverage) is preferably 50 to 90%. The surface coverage can also be determined by observation through TEM. Preferably, one layer of hemispherical carbon particles 2 is formed on the surface of the active material particle 1, but the surface of one spherical carbon particle 2 may be overlaid with another. From the viewpoints of ionic and electronic conductivities, the number of layers of hemispherical carbon particles 2 is preferably 2 or less. The hemispherical carbon particles 2 derive from carbon black, for example.

By having the structure mentioned above, the active material 5 can yield a sufficient discharge capacity at a high discharge current density. The reason therefor is not clear but inferred as follows. Firstly, by containing the active material particle 1 mainly composed of LiVOPO₄ having the β-type crystal structure and a plurality of hemispherical carbon particles 2 having a height h of 5 to 20 nm supported on the surface of the active material particle 1 and having the average primary particle size R₅ of 50 to 1000 nm, the particle size R₁ of the active material particle 1 becomes equivalent to or less than 50 to 1000 nm, thus yielding a greater specific surface area, thereby increasing the contact area with an electrolytic solution. This seems to make it easier to diffuse lithium ions into crystal lattices of LiVOPO₄, thereby facilitating the insertion and desorption of lithium ions. Secondly, since the carbon particles 2 in the active material 5 have a height of 5 to 20 nm and a hemispherical form, the contact area between the active material particle 1 and the electrolytic solution becomes greater than that in the case where a film is formed by a carbon material, for example, whereby the ionic conductivity is secured; while the contact area between the active material particle 1 and the carbon particles 2 becomes greater than that in the case where spherical carbon particles are supported, for example, whereby the electronic conductivity is secured. This seems to make it possible to satisfy the ionic and electronic conductivities at the same time.

Method of Manufacturing the Active Material

The method of manufacturing the active material 5 will now be explained. The method of manufacturing the active material 5 in accordance with the second embodiment comprises a hydrothermal synthesis step of heating a mixture containing a lithium source, a vanadium source, a phosphate source, carbon black, and water and having a pH of 7 or less, so as to yield a precursor of LiVOPO₄ having the β-type crystal structure; and a firing step of heating the precursor of LiVOPO₄ having the n-type crystal structure at 530 to 670° C., so as to yield LiVOPO₄ having the β-type crystal structure.

Hydrothermal Synthesis Step

Material

The material used for the hydrothermal synthesis step is a mixture containing, at least, a lithium source, a vanadium source, a phosphate source, carbon black, and water.

Examples of the lithium source include lithium compounds such as LiNO₃, Li₂CO₃, LiOH, LiCl, Li₂SO₄, and CH₃COOLi. Preferred among them are LiNO₃ and Li₂CO₃.

Examples of the vanadium source include vanadium compounds such as V₂O₅ and NH₄VO₃.

Examples of the phosphate source include PO₄-containing compounds such as H₃PO₄, NH₄H₂PO₄, (NH₄)₂HPO₄, and Li₃PO₄. Preferred among them are H₃PO₄ and (NH₄)₂HPO₄.

It will be sufficient if the compound ratio of the lithium, phosphate, and vanadium sources in the material used for the hydrothermal synthesis step is adjusted such as to yield a composition represented by the formula of LiVOPO₄, i.e., Li:V:P:O=1:1:1:5 (molar ratio).

Carbon black is added to the mixture to become the above-mentioned material in order to support the hemispherical carbon particles 2 on the surface of the active material 1. For carbon black, one commercially available having a particle size of 30 to 100 nm can be used, for example, though not restricted in particular. Substantially spherical carbon black supplied as the material will become hemispherical, which may be due to its hardness, after the hydrothermal synthesis step and a firing step which will be explained later, so as to be supported on the surface of the active material 1. Carbon black can easily be dispersed into the aqueous solution to become the above-mentioned material at the time of the hydrothermal synthesis.

Preferably, the carbon black content in the mixture to become the material of the hydrothermal synthesis is adjusted such that the number of moles C1 of carbon atoms constituting carbon black and the number of moles M of vanadium atoms contained in the vanadium compound, for example, satisfy the relationship of 0.04≦C1/M≦4. When the carbon atom content (number of moles C1) is too small, the electronic conductivity and capacity density of the active material 5 tend to decrease. When the carbon atom content is too large, the weight occupied by the active material particle 1 in the active material 5 tends to decrease relatively, thereby reducing the capacity density of the active material. These tendencies can be suppressed when the carbon atom content falls within the range mentioned above.

For obtaining the precursor of LiVOPO₄ having the β-type crystal structure by the hydrothermal synthesis, the pH of the above-mentioned mixture is adjusted to 7 or less, for example. The pH can be adjusted not only by species of compounds to become the lithium, phosphate, and vanadium sources, but also by using pH adjusters such as hydrochloric acid and aqueous ammonia. Instead of adjusting the pH to 7 or less, a peroxide such as H₂O₂, for example, may be mixed with the material, so as to place the material into an oxidizing atmosphere, whereby the precursor of LiVOPO₄ having the β-type crystal structure can be obtained. A precursor of LiVOPO₄ having the α-type crystal structure tends to be easier to occur when the pH exceeds 7.

Hydrothermal Synthesis

First, in the hydrothermal synthesis step, the above-mentioned materials for the precursor (e.g., a lithium compound, a vanadium compound, a PO₄-containing compound, carbon black, and water) are put into a reaction vessel having a function of pressurizing and heating the inside thereof (e.g., autoclave), so as to prepare an aqueous solution (hereinafter referred to as “material mixture”) having them dispersed therein. For preparing the mixture, the materials for the precursor may be mixed at once, stirred for a fixed time thereafter, and then refluxed, or a mixture of the vanadium compound, PO₄-containing compound, carbon black, and water may be refluxed at first before adding the lithium compound and carbon black thereto, for example. The reflux can form a complex of the vanadium compound and the PO₄-containing compound.

Next, the reaction vessel is closed, and the mixture is heated under pressure, so that a hydrothermal reaction of the mixture proceeds. This hydrothermally synthesizes a substance containing a precursor of LiVOPO₄ having the β-type crystal structure.

The substance containing the precursor of LiVOPO₄ having the β-type crystal structure is typically a pasty substance having a low fluidity. The precursor of LiVOPO₄ having the β-type crystal structure contained in the substance seems to be in a hydrate state.

Preferably, the pressure applied to the material mixture in the hydrothermal synthesis step is 0.1 to 30 MPa. When the pressure applied to the mixture is too low, the finally obtained active material particle mainly composed of LiVOPO₄ having the β-type structure tends to lower its crystallinity, thereby decreasing the capacity density of the active material. When the pressure applied to the mixture is too high, the reaction vessel tends to require a high pressure resistance, thereby increasing the cost for manufacturing the active material. These tendencies can be suppressed when the pressure applied to the material mixture falls within the range mentioned above.

Preferably, the temperature of the material mixture in the hydrothermal synthesis step is 120 to 200° C. When the temperature of the mixture is too low, the finally obtained active material particle mainly composed of LiVOPO₄ having the β-type structure tends to lower its crystallinity, thereby decreasing the capacity density of the active material. When the temperature of the mixture is too high, the reaction vessel tends to require a high heat resistance, thereby increasing the cost for manufacturing the active material. These tendencies can be suppressed when the temperature of the mixture falls within the range mentioned above.

Firing Step Next, a firing step for heating thus obtained precursor to 530 to 670° C. is carried out. This completes the crystallization of the active material particle 1 and the supporting of the hemispherical carbon particles 2, thereby yielding the above-mentioned active material 5. This step seems to remove the impurities and the like remaining in the mixture after the hydrothermal synthesis step and dehydrate and crystallize the precursor of LiVOPO₄ having the β-type structure. While the precursor obtained in the hydrothermal synthesis step seems to contain carbon components derived from carbon black, firing the precursor within the above-mentioned temperature range causes the surface of the active material particle 1 to support the hemispherical carbon particles 2. When the heating temperature is lower than the lower limit of the above-mentioned range, the surface of carbon tends to be covered with the active material particle, which may be due to the fact that the active material particle fails to grow sufficiently. When the heating temperature is higher than the upper limit of the above-mentioned range, on the other hand, the active material particle 1 tends to reduce the ratio of the β phase.

Preferably, the above-mentioned precursor is heated for 0.5 to 10 hr at 530 to 670° C. in the firing step. When the heating time is too short, the finally obtained active material particle mainly composed of LiVOPO₄ having the β-type structure tends to lower its crystallinity, thereby decreasing the capacity density of the active material. When the heating time is too long, on the other hand, the active material particle tends to grow, so as to increase the particle size, thereby retarding the diffusion of lithium in the active material and lowering the capacity density of the active material. These tendencies can be suppressed when the heating time falls within the range mentioned above.

For keeping carbon black from being oxidized, the firing step is preferably carried out in an inert atmosphere constituted by an argon gas, a nitrogen gas, or the like, though the atmosphere for the firing step is not restricted in particular. An inert gas atmosphere may be provided within a furnace, which is covered with a vessel containing activated carbon and so forth, so as to yield a reducing atmosphere.

The method of manufacturing an active material in accordance with the second embodiment synthesizes β-LiVOPO₄ by a hydrothermal synthesis and thus permits β-LiVOPO₄ as an active material particle to have an average primary particle size equivalent to or less than 50 to 1000 nm and support hemispherical carbon particles in a predetermined particle size range on the surface of the active material particle, whereby the above-mentioned active material 5 can be manufactured easily. Also, the particle size distribution of the active material particle 1 can be made sharper.

A conductive material such as a carbon material is often typically brought into contact with the surface of an active material in a layer containing the active material in an electrode in order to enhance the conductivity. As a method therefor, the active material and the conductive material may be mixed after manufacturing the active material, so as to form the active material containing layer, or a conductive material which is a carbon material other than carbon black may be added into the material for the hydrothermal synthesis, so as to attach carbon to the active material particle, for example.

Examples of the conductive material as a carbon material to be added into the material for the hydrothermal synthesis include activated carbon, graphite, soft carbon, and hard carbon. Preferred among them is activated carbon which can easily disperse carbon particles into the mixture (aqueous solution) to become the above-mentioned material at the time of the hydrothermal synthesis. However, it is not always necessary for the whole amount of the conductive material to be mixed with the mixture to become the material at the time of the hydrothermal synthesis, but at least a part thereof is preferably mixed with the mixture to become the material at the time of the hydrothermal synthesis. This may lower the amount of binders for forming the active material containing layer, thereby increasing the capacity density.

Preferably, the content of the above-mentioned conductive material such as carbon particles in the mixture to become the material of the hydrothermal synthesis is adjusted such that the number of moles C2 of carbon atoms constituting carbon particles and the number of moles M of vanadium atoms contained in the vanadium compound, for example, satisfy the relationship of 0.04≦C2/M≦4. When the conductive material content (number of moles C2) is too small, the electronic conductivity and capacity density of the electrode active material constituted by the active material 5 and the conductive material tend to decrease. When the conductive material content is too large, the weight occupied by the active material particle in the electrode active material tends to decrease relatively, thereby not only reducing the capacity density of the active material but also making it harder for the spherical carbon particles 2 to be supported in a desirable state on the surface active material particle 1. These tendencies can be suppressed when the conductive material content falls within the range mentioned above.

Lithium-Ion Secondary Battery

The electrode and lithium-ion secondary battery in accordance with the second embodiment will now be explained with reference to FIG. 3.

A lithium-ion secondary battery 100 mainly comprises a multilayer body 30, a case 50 accommodating the multilayer body 30 in a closed state, and a pair of leads 60, 62 connected to the multilayer body 30.

The multilayer body 30 is one in which a pair of electrodes 10, 20 are arranged such as to oppose each, other while interposing a separator 18 therebetween. The positive electrode 10 is one in which a positive electrode active material layer 14 is disposed on a positive electrode current collector 12. The negative electrode 20 is one in which a negative electrode active material layer 24 is disposed on a negative electrode current collector 22. The positive electrode active material layer 14 and negative electrode active material layer 24 are in contact with the separator 18 on the respective sides thereof. The leads 60, 62 are connected to respective end parts of the negative electrode current collector 22 and positive electrode current collector 12, while end parts of the leads 60, 62 extend to the outside of the case 50.

As the positive electrode current collector 12 of the positive electrode 10, an aluminum foil can be used, for example. The positive electrode current collector 12 is a layer containing the above-mentioned active material 5, a binder, and a conductive material added when necessary. Examples of the conductive material added when necessary include carbon blacks, carbon materials, and conductive oxides such as ITO.

The binder is not restricted in particular as long as it can bind the above-mentioned active material 5 and conductive material to the current collector, whereby known binders can be used. Its examples include fluororesins such as polyvinylidene fluoride (PVDF), polytetrafluoroethylene (PTFE), and vinylidene fluoride/hexafluoropropylene copolymers.

Such a positive electrode can be manufactured by a known method, for example, by coating the surface of the positive electrode current collector 12 with a slurry formed by adding the electrode active material containing the above-mentioned active material 5 or the active material 5, binder, and conductive material into a solvent corresponding to their species, e.g., N-methyl-2-pyrrolidone, N,N-dimethylformamide, or the like in the case of PVDF, and drying the slurry.

As the negative electrode current collector 22, a copper foil or the like can be used. As the negative electrode active material layer 24, one containing a negative electrode active material, a conductive material, and a binder can be used. As the conductive material, known conductive materials can be used without being restricted in particular. Its examples include carbon blacks, carbon materials, powders of metals such as copper, nickel, stainless steel, and iron, mixtures of the carbon materials and metal powders, and conductive oxides such as ITO. As the binder for use in the negative electrode, known binders can be used without being restricted in particular. Its examples include fluororesins such as polyvinylidene fluoride (PVDF), polytetrafluoroethylene (PTFE), tetrafluoroethylene/hexafluoropropylene copolymers (FEF), tetrafluoroethylene/perfluoroalkylvinylether copolymers (PFA), ethylene/tetrafluoroethylene copolymers (ETFE), polychlorotrifluoroethylene (PCTFE), ethylene/chlorotrifluoroethylene copolymers (ECTFE), and polyvinyl fluoride (PVF). The binder not only binds constituent materials such as the active material particle and the conductive material added when necessary to each other, but also contributes to binding these constituent materials to the current collector. Other examples of the binder include polyethylene, polypropylene, polyethylene terephthalate, aromatic polyamides, cellulose, styrene/butadiene rubber, isoprene rubber, butadiene rubber, and ethylene/propylene rubber. Also usable are thermoplastic elastomeric polymers such as styrene/butadiene/styrene block copolymers and their hydrogenated derivatives, styrene ethylene/butadiene/styrene copolymers, and styrene/isoprene/styrene block copolymers and their hydrogenated derivatives. Further, syndiotactic 1,2-polybutadiene, ethylene/vinyl acetate copolymers, propylene-α-olefin copolymers (having a carbon number of 2 to 12), and the like may be used. Conductive polymers may also be used.

Examples of the negative, electrode active material include carbon materials such as graphite, non-graphitizing carbon, graphitizable carbon, and low-temperature-firable carbon which can occlude and release (intercalate and deintercalate or be doped and undoped with) lithium ions; metals such as Al, Si, and Sn which are combinable with lithium; amorphous compounds mainly composed of oxides such as SiO₂ and SnO₂; and particles containing lithium titanate (Li₄Ti₅O₁₂) and the like.

The negative electrode 20 may be manufactured by preparing a slurry and applying it to the current collector as in the method of manufacturing the positive electrode 10.

The electrolytic solution is one contained within the positive electrode active material layer 14, negative electrode active material layer 24, and separator 18. The electrolytic solution is not limited in particular. For example, an electrolytic solution (an aqueous solution or an electrolytic solution using an organic solvent) containing a lithium salt can be used in the second embodiment. Since the tolerable voltage of aqueous electrolytic solutions during charging is limited to a low level because of their electrochemically low decomposition voltage, electrolytic solutions using organic solvents (nonaqueous electrolytic solutions) are preferred. As the electrolytic solution, one dissolving a lithium salt into a nonaqueous solvent (organic solvent) is preferably used. Examples of the lithium salt include salts such as LiPF₆, LiClO₄, LiBF₄, LiAsF₆, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, and LiBOB. These salts may be used either singly or in combinations of two or more.

Preferred examples of the organic solvent include propylene carbonate, ethylene carbonate, diethyl carbonate, dimethyl carbonate, and methylethyl carbonate. They may be used either singly or in combinations of two or more in given ratios.

In the second embodiment, the electrolytic solution may be not only a liquid but also a gelled electrolyte obtained by adding a gelling agent thereto. A solid electrolyte (a solid polymer electrolyte or an electrolyte made of an ionically conductive organic material) may be contained in place of the electrolytic solution.

It will be sufficient if the separator 18 is formed by an electrically insulating porous structure. Its examples include monolayer or multilayer bodies of films constituted by any of polyethylene, polypropylene, and polyolefin, extended films of mixtures of these resins, and fibrous nonwovens constituted by at least one kind of constituent material selected from the group consisting of cellulose, polyester, and polypropylene.

The case 50 is one which seals the multilayer body 30 and electrolytic solution therein. The case 50 is not limited in particular as long as it can inhibit the electrolytic solution from leaking out therefrom and moisture and the like from invading the lithium-ion secondary battery 100 from the outside. For example, as illustrated in FIG. 3, a metal-laminated film in which a metal foil 52 is coated with polymer films 54 on both sides can be utilized as the case 50. An aluminum foil can be used as the metal foil 52, for example, while films of polypropylene and the like can be used as the polymer films 54. Preferred examples of the material for the outer polymer film 54 include polymers having a high melting point such as polyethylene terephthalate (PET) and polyamide. Preferred examples of the material for the inner polymer film 54 include polyethylene and polypropylene.

The leads 60, 62 are formed from a conductive material such as aluminum.

Though the active material, electrode containing the active material, battery comprising the electrode, and method of manufacturing the active material in accordance with the second embodiment are explained in detail in the foregoing, the second aspect of the present invention is not limited to the second embodiment.

For example, the active material can also be used as an electrode material for electrochemical devices other than the lithium-ion secondary battery. Examples of such electrochemical devices include secondary batteries other than the lithium-ion secondary battery, e.g., metallic lithium secondary batteries (using an electrode containing the active material of the second aspect of the present invention as a cathode and metallic lithium as an anode), and electrochemical capacitors such as lithium capacitors. These electrochemical devices can be used for power supplies for self-propelled micromachines, IC cards, and the like and decentralized power supplies placed on or within printed boards.

### EXAMPLES OF SECOND ASPECT OF INVENTION

The second aspect of the present invention will now be explained more specifically with reference to examples and comparative examples, but will not be limited to the following Examples 11 to 17.

### Example 11

### Hydrothermal Synthesis Step

Into a 1.5-L autoclave vessel, 34.59 g (0.35 mol) of H₃PO₄ (special grade having a molecular weight of 98.00 and a purity of 85 wt % manufactured by Nacalai Tesque, Inc.), 750 g of H₂O (for HPLC (high-performance liquid chromatography), manufactured by Nacalai Tesque, Inc.), 27.56 g (0.15 mol) of V₂O₅ (special grade having a molecular weight of 181.88 and a purity of 99 wt % manufactured by Nacalai Tesque, Inc.), 112 g (0.15 mol) of Li₂CO₃ (special grade having a molecular weight of 73.89 and a purity of 99 wt % manufactured by Nacalai Tesque, Inc.), and 1.52 g (0.13 mol) of carbon black (CB) (having a molecular weight of 12 and an average particle size of 50 nm manufactured by Denki Kagaku Kogyo K.K.) were introduced in this order, so as to prepare a mixture having a pH of 3.5. These amounts of materials correspond to amounts for stoichiometrically generating about 50 g (0.3 mol) of LiVOPO₄ (having a molecular weight of 168.85).

With the vessel closed, the mixture was stirred for about 30 min at room temperature, and then was subjected to a hydrothermal synthesis reaction for 16 hr at a temperature of 160° C. under a pressure of 0.5 MPa within the vessel. After the hydrothermal synthesis reaction, the pH of the mixture was 2.7.

The pasty mixture obtained after the hydrothermal synthesis reaction was transferred onto a tray and dried for about 21 hr at 90° C. by evaporation. Thereafter, the sample was turned upside down and further dried for about 5 hr at 90° C. by evaporation. After being dried by evaporation, the mixture was pulverized by a small-size pulverizer (SK-M500 manufactured by Kyoritsu Riko K.K.), so as to yield a black green powder (a precursor of an active material).

Firing Step In an alumina crucible, 5.00 g of the precursor were heated from room temperature to 600° C. at a heating rate of 100° C./min. After being held at 600° C. for 4 hr, the precursor was cooled to room temperature at a rate of 10° C./min. During heating and cooling, a nitrogen gas was caused to flow at 5 L/min from 200° C., so as to form a nitrogen atmosphere within the furnace. This firing step yielded 40.43 g of a somber green particle group (an active material of Example 11).

Measurement of the Crystal Structure

The result of powder X-ray diffraction' (XRD) proved that the active material of Example 1 had the β-type crystal structure of LiVOPO₄.

Measurement of the Number-Based Particle Size Distribution and the Average Primary Particle Size

The number-based particle size distribution of the active material of Example 11 was calculated from the cumulative ratio of the projected area circle-equivalent diameter determined from a projected area of the active material based on an image observed through a high-resolution scanning electron microscope. According to thus obtained number-based particle size distribution of the active material, the average primary particle size (d50) of the active material was calculated. The average primary particle size (d50) of the active material was 500 nm.

Observation of the Form of Carbon Particles and Measurement of their Size

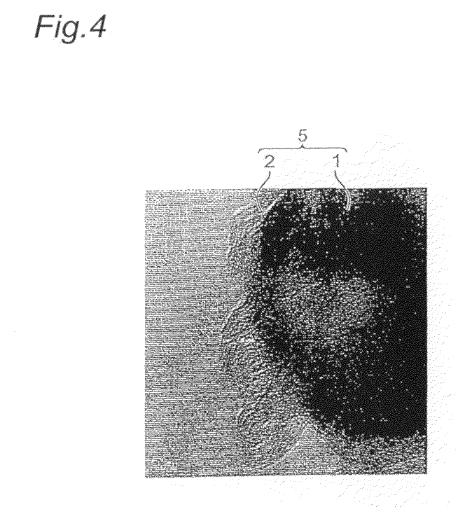

The active material of the example was observed through TEM. The form of carbon particles supported on the surface of the active material particle was observed, and their size was measured. FIG. 4 illustrates a TEM image of the active material of Example 13 as an example. Hemispherical CB particles were supported on the surface of the active material particle. The average height h from the active material particle surface to the highest position of the hemispherical CB particle was about 9 nm.

Measurement of the Discharge Capacity

The active material of Example 11 and a mixture of polyvinylidene fluoride (PVDF) as a binder and acetylene black were dispersed into N-methyl-2-pyrrolidone (NMP) acting as a solvent, so as to prepare a slurry. The slurry was prepared such that the active material, acetylene black, and PVDF had a weight ratio of 84:8:8. The slurry was applied onto an aluminum foil acting as a current collector, dried, and then extended under pressure, so as to yield an electrode (positive electrode) formed with an active material layer containing the active material of Example 11.

Thus obtained electrode and an Li foil acting as its opposite electrode were subsequently laminated with a separator made of a microporous polyethylene film interposed therebetween, so as to yield a multilayer body (matrix). This multilayer body was put into an aluminum-laminated pack, a 1-M LiPF₆ solution was injected therein as an electrolytic solution, and then the pack was sealed in vacuum, so as to make an evaluation cell of Example 11.

Using the evaluation cell of Example 11, the discharge capacity (unit: mAh/g) at a discharge rate of 0.1 C (the current value by which constant-current discharging at 25° C. completed in 10 hr) was measured. The discharge capacity at 0.1 C was 120 mAh/g.

### Example 12

An active material was made as in Example 11 except that the pH before the hydrothermal synthesis was changed to 1.8 by addition of hydrochloric acid.

### Example 13

An active material was made as in Example 11 except that the pH before the hydrothermal synthesis was changed to 3.6 by addition of hydrochloric acid.

### Example 14

An active material was made as in Example 11 except that the pH before the hydrothermal synthesis was changed to 2.5 by addition of hydrochloric acid.

### Example 15

An active material was made as in Example 11 except that the pH before the hydrothermal synthesis was changed to 6.5 by addition of hydrochloric acid.

### Example 16

An active material was made as in Example 11 except that the pH before the hydrothermal synthesis was changed to 2.5 by addition of hydrochloric acid and that the fixing temperature was 550° C.

### Example 17

An active material was made as in Example 11 except that the pH before the hydrothermal synthesis was changed to 2.5 by addition of hydrochloric acid and that the firing temperature was 650° C.

### Comparative Example 11

An active material was made as in Example 14 except that the carbon material was graphite.

### Comparative Example 12

An active material was made as in Example 14 except that the firing temperature was 500° C.

### Comparative Example 13

An active material was made as in Example 11 except that the pH before the hydrothermal synthesis was changed to 7.8 by addition of aqueous ammonia.

### Comparative Example 14

An active material was made as in Example 11 except that the pH before the hydrothermal synthesis was changed to 9.2 by addition of aqueous ammonia.

### Comparative Example 15

An active material was made as in Example 11 except that the pH before the hydrothermal synthesis was changed to 8.1 by addition of aqueous ammonia.

### Comparative Example 16

An active material was made by the following solid-phase method without a hydrothermal synthesis.

LiNO₃, V₂O₅, and H₃PO₄ were dissolved into water at a molar ratio of 2:1:2 and stirred at 80° C. The resulting solution was dried by evaporation, dried for one night at 110° C., pulverized thereafter, and then fired for 14 hr at 700° C. in the air. The X-ray diffraction pattern of the resulting powder showed that active material particle was the β type (orthorhombic crystal). Thus obtained powder was mixed with 3 mass % of carbon black and pulverized in a ball mill, so as to make an active material.

### Comparative Example 17

An active material was made as in Example 11 except that carbon black was not added to the materials used for the hydrothermal synthesis but to the precursor of LiVOPO₄ having the β-type crystal structure after 16 hr of the hydrothermal synthesis step and that they were dry-mixed.

Table 3 represents the experimental conditions and measurement results of Examples 11 to 17 and Comparative Examples 11 to 17 mentioned above.

TABLE 3

| | | | | | | Active | | | |
|---|---|---|---|---|---|---|---|---|---|
| | | | | | | material | Active material | | 0.1 C |
| | Active | | pH before and after | | | particle | average primary | | discharge |
| | material | Carbon | hydrothermal synthesis | | Firing temp. | crystal | particle size | Form of carbon | capacity |
| | particle | source | Before | After | (° C.) | structure | (nm) | material supported | (mAh/g) |
| Example 11 | LiVOPO₄ | CB | 3.5 | 2.7 | 600 | β | 500 | hemispherical(h = 9 nm) | 120 |
| Example 12 | LiVOPO₄ | CB | 1.8 | 1.3 | 600 | β | 460 | hemispherical(h = 7 nm) | 116 |
| Example 13 | LiVOPO₄ | CB | 3.6 | 3 | 600 | β | 570 | hemispherical(h = 10 nm) | 128 |
| Example 14 | LiVOPO₄ | CB | 2.5 | 2.2 | 600 | β | 480 | hemispherical(h = 15 nm) | 130 |
| Example 15 | LiVOPO₄ | CB | 6.5 | 4 | 600 | β | 630 | hemispherical(h = 18 nm) | 118 |
| Example 16 | LiVOPO₄ | CB | 2.5 | 2.1 | 550 | β | 260 | hemispherical(h = 6 nm) | 93 |
| Example 17 | LiVOPO₄ | CB | 2.5 | 2.1 | 650 | β | 890 | hemispherical(h = 12 nm) | 123 |
| Comparative | LiVOPO₄ | graphite | 2.5 | 2.2 | 600 | β | 510 | scaly dots | 80 |
| Example 11 | | | | | | | | | |
| Comparative | LiVOPO₄ | CB | 2.5 | 2.2 | 500 | β | 470 | carbon covered with | 75 |
| Example 12 | | | | | | | | active material particle | |
| Comparative | LiVOPO₄ | CB | 7.8 | 4.5 | 600 | α | 760 | hemispherical(h = 19 nm) | 85 |
| Example 13 | | | | | | | | | |
| Comparative | LiVOPO₄ | CB | 9.2 | 5.5 | 600 | α | 650 | hemispherical(h = 30 nm) | 73 |
| Example 14 | | | | | | | | | |
| Comparative | LiVOPO₄ | CB | 8.1 | 4.6 | 600 | α | 550 | hemispherical(h = 20 nm) | 82 |
| Example 15 | | | | | | | | | |
| Comparative | LiVOPO₄ | CB | 2.5 | 2.2 | 700 | β | 1560 | small particle size dots | 82 |
| Example 16 | | | | | | | | | |
| Comparative | LiVOPO₄ | CB*¹ | 6.5 | 4 | 600 | β | 540 | spherical | 90 |
| Example 17 | | | | | | | | (as before synthesis) | |

*¹CB was added after 16 hr of the hydrothermal synthesis.

Each of Examples 11 to 17 yielded an active material having an average primary particle size of 260 to 890 nm in which hemispherical carbon particles having a height of 6 to 18 nm were supported on LiVOPO₄ having the β-type crystal structure and exhibited a high discharge capacity of 93 to 130 mAh/g at 0.1 C.

Dots of carbon particles existed on the surface of LiVOPO₄ having the β-type crystal structure like scales (with a size of about 20 μm) in Comparative Example 11 and with small particle sizes (about 50 nm) in Comparative Example 16. In Comparative Example 12, LiVOPO₄ having the β-type crystal structure became fine particles and covered the surfaces of carbon particles. Though Comparative Examples 13 to 15 yielded active materials supporting hemispherical carbon particles, the active material particles were constituted by LiVOPO₄ having the α-type crystal structure. Carbon black was added after the hydrothermal synthesis in Comparative Example 17 and thus failed to become hemispherical, thereby being supported on the surface of LiVOPO₄ having the β-type crystal structure in the same (spherical) form as that before the addition. In each of Examples, the discharge capacity at 0.1 C was lower than that in any of Comparative Examples 11 to 17.

The active material and the electrode containing the same in accordance with the second aspect of the present invention can provide a lithium-ion secondary battery attaining a sufficient discharge capacity at a high discharge current density. The method of manufacturing an active material in accordance with the second aspect of the present invention can provide an active material capable of attaining a sufficient discharge capacity at a high discharge current density.

### REFERENCE SIGNS LIST OF FIGS. 2 TO 4

1 . . . active material particle; 2 . . . carbon particle; 5 . . . active material; h . . . carbon particle height; R₁ . . . active material particle size; R₅ . . . active material average primary particle size; 10, 20 . . . electrode; 12 . . . positive electrode current collector; 14 . . . positive electrode active material layer; 18 . . . separator; 22 . . . negative electrode current collector; 24 . . . negative electrode active material layer; 30 . . . multilayer body; 50 . . . case; 52 . . . metal foil; 54 . . . polymer film; 60, 62 . . . lead; 100 . . . lithium-ion secondary battery

What is claimed is:

1. A method of manufacturing an active material, the method comprising:
a hydrothermal synthesis step of heating a mixture containing a lithium source, a phosphate source, a vanadium source, and water and having a pH of 7 or less; and
a firing step of firing the mixture after being heated under pressure in the hydrothermal synthesis step.

2. A method of manufacturing an active material according to claim 1, wherein at least one of nitric acid, hydrochloric acid, and sulfuric acid is added to the mixture before being heated in the hydrothermal synthesis step.

3. A method of manufacturing an active material according to claim 1, wherein the lithium source is at least one species selected from the group consisting of LiNO₃, Li₂CO₃, LiOH, LiCl, Li₂SO₄, and CH₃COOLi;
the phosphate source is at least one species selected from the group consisting of H₃PO₄, NH₄H₂PO₄, (NH₄)₂HPO₄, and Li₃PO₄; and
the vanadium source is at least one species selected from the group consisting of V₂O₅ and NH₄VO₃.

4. A method of manufacturing an active material according to claim 1, wherein the lithium source is Li₂CO₃;
the phosphate source is H₃PO₄; and
the vanadium source is V₂O₅.

5. An active material comprising a particle group having a β-type crystal structure of LiVOPO₄ and a volume-average primary particle size of 50 to 1000 nm.

6. An active material according to claim 5, wherein, as counted from the smaller primary particle side in a volume-based particle size distribution of the particle group determined by a laser scattering method,
a primary particle size d10 at a cumulative volume ratio of 10% is 0.2 to 1.5 nm;
a primary particle size d50 at a cumulative volume ratio of 50% is 2 to 10 nm; and
a primary particle size d90 at a cumulative volume ratio of 90% is 15 to 50 nm.

7. An active material according to claim 5, wherein the particle group has a specific surface area of 1 to 10 m²/g.

8. An electrode comprising:
a current collector; and
an active material layer, disposed on the current collector, containing the active material according to claim 5.

9. An electrode according to claim 8, wherein the active material layer contains 80 to 97 mass % of the particle group.

10. A lithium-ion secondary battery comprising the electrode according to claim 8.

11. An active material containing:
an active material particle mainly composed of LiVOPO₄ having a β-type crystal structure; and
a plurality of hemispherical carbon particles, supported on a surface of the active material particle, having a height of 5 to 20 nm;
the active material having an average primary particle size of 50 to 1000 nm.

12. An electrode comprising:
a current collector; and
an active material layer, disposed on the current collector, containing the active material according to claim 11.

13. A lithium-ion secondary battery comprising the electrode according to claim 12.

14. A method of manufacturing an active material, the method comprising:
a hydrothermal synthesis step of heating a mixture containing a lithium source, a vanadium source, a phosphate source, carbon black, and water and having a pH of 7 or less, so as to yield a precursor of LiVOPO₄ having a β-type crystal structure; and
a firing step of heating the precursor of LiVOPO₄ having the β-type crystal structure at 530 to 670° C., so as to yield LiVOPO₄ having the β-type crystal structure.
